(19) United States
(12) Patent Application Publication
(10) Pub. No.: US 2011/0225464 A1
(43) Pub. Date: Sep. 15, 2011

(54) RESILIENT CONNECTIVITY HEALTH MANAGEMENT FRAMEWORK

(75) Inventors: Shai Guday, Redmond, WA (US); Thomas W. Kuehnel, Seattle, WA (US); Gregory J. Scott, Seattle, WA (US); Alec G. Kwok, Remond, WA (US); Chao Li, Redmond, WA (US); Yang Zhang, Bellevue, WA (US); Naile Daoud, Woodinville, WA (US)

(73) Assignee: Microsoft Corporation, Redmond, WA (US)

(21) Appl. No.: 12/827,349

(22) Filed: Jun. 30, 2010

Related U.S. Application Data
(60) Provisional application No. 61/313,480, filed on Mar. 12, 2010.

(51) Int. Cl. G06F 11/00

(52) U.S. Cl. 714/48; 714/E11.001

(57) ABSTRACT

A framework is provided for diagnosing and resolving wireless connectivity-related issues. For example, some embodiments of the invention provide a “health monitor” which monitors and logs wireless connectivity-related events occurring on the device, the network, and the one or more resources to which the device is connected. The health monitor may analyze these events and/or other information to determine when a connectivity problem may have arisen, and if a problem is determined to be imminent or to have occurred, may initiate recovery procedures. In some embodiments, the monitoring of events, analysis to determine whether a connectivity problem has arisen, and the recovery from the problem occur transparently to the user.

### RELATED APPLICATIONS

This application claims priority under 35 U.S.C.§119(e) to U.S. Provisional Application Ser. No. 61/313,480, entitled “Resilient Connectivity Health Management Framework,” filed on Mar. 12, 2010, which is incorporated herein by reference in its entirety.

### FIELD OF INVENTION

This invention relates generally to wireless connectivity, and more specifically to the management of wireless connectivity-related issues.

### BACKGROUND OF INVENTION

Some conventional handheld devices provide access to one or more networks (e.g., the Internet, a local area network, another type of network, or any combination thereof) via a wireless (e.g., radio frequency, or RF) connection. For example, many handheld devices employ an RF connection to provide users with access to email, web browsing, and high-quality video, among other services. A handheld device may, for example, run an operating system which manages connectivity to a mobile operator's network through which the Internet is accessed, and provides a standardized interface and platform upon which applications execute on the device.

Connectivity problems commonly plague handheld devices which employ RF connections to connect to one or more networks. Connectivity problems may arise due to, for example, the characteristics of the environment in which a device is used, a problem with one or more components in a mobile operator's network, issues with a server or service to which the user attempts a connection, and/or problems with the device itself. Connectivity problems may result in the termination of, and/or impact the quality of a connection.

Many conventional handheld devices include components that attempt to minimize connectivity-related problems. For example, if a problem arises with a connection, these components may take action to attempt to maintain the connection, or if the connection has already been lost, attempt to re-establish it. However, there are numerous variables that can affect the quality of a connection, and numerous components required to maintain it. As a result, it is difficult to foresee all of the types of error conditions and scenarios that may arise, and account for all of these conditions and scenarios in programmed logic on a device.

As an example, a frequent cause of connectivity problems on handheld devices is a mismatch in states between components. States may become mismatched or out of sync after a connection has been established due to any of numerous events. For example, some mobile network operators have in place policies to manage network resources, which policies provide that a connection which remains idle for longer than a specified period (e.g., thirty minutes) is automatically and silently disconnected. After the connection is severed, the network components that formerly facilitated the connection may be re-deployed to service other traffic, even though components on the handheld device “believe” the connection is still intact. The complexities associated with maintaining a connection, such as preventing or resolving state mismatches, make managing connectivity-related problems on handheld devices difficult.

### SUMMARY

Some embodiments of the invention provide a framework for diagnosing and resolving connectivity-related problems quickly, so as to minimize their impact. For example, some embodiments of the invention provide a “health monitor” which monitors and logs connectivity-related events occurring on the device, the network, and the one or more resources to which the device is connected. The health monitor analyzes these events and/or other information to determine when a connectivity problem may have arisen, and if a problem is determined to be imminent or to have occurred, initiates recovery procedures. In some embodiments, the monitoring of events, analysis to determine whether a connectivity problem has arisen, and the recovery from the problem all occur transparently to the user.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting example components of a health monitor implemented in accordance with some embodiments of the invention;

FIG. 2 is a state diagram depicting example states of components of a health monitor implemented in accordance with some embodiments of the invention;

FIG. 3 is a sequence diagram depicting an example process performed by a health monitor implemented in accordance with some embodiments of the invention;

FIG. 4 is a block diagram depicting an example interface between one or more applications and a health monitor implemented in accordance with some embodiments of the invention;

FIG. 5 is a block diagram depicting an example system for exchanging devices between one or more handheld devices and one or more analysis facilities, in accordance with some embodiments of the invention;

FIG. 6 is a block diagram depicting an example computer on which some embodiments of the invention may be implemented; and

FIG. 7 is a block diagram depicting an example storage medium on which instructions and data implementing embodiments of the invention may be stored.

### DESCRIPTION

Some embodiments of the invention provide a framework for diagnosing and resolving connectivity-related problems. For example, some embodiments of the invention provide a “health monitor” which monitors and logs connectivity-related events occurring on a handheld device, the network, and/or one or more network-accessible resources to which the device is connected. The health monitor may analyze these events and/or other information, so as to identify a connectivity-related problem, and if a problem is identified or determined to be imminent, may initiate recovery procedures. The monitoring and analysis of events to identify present or imminent connectivity-related problems may, in some embodiments, occur transparently to the user of the handheld device.

In some embodiments of the invention, the health monitor is implemented via components of an operating system executing on a handheld device. For example, the health monitor may include a set of components each designed to “mirror” one of the seven layers of the Open Systems Interconnection (OSI) stack that is commonly employed to perform network communications. As those skilled in the art will appreciate, the OSI stack is a conceptual framework for protocols and services used in performing network communications. The seven layers of the OSI stack include the application, presentation, session, transport, network, data link, and physical layers. A protocol is typically employed for a given communication at each layer of the stack, which layer includes a collection of conceptually similar functions that provide services to the layer immediately above, and receives services from the layer immediately below. Some embodiments of the invention provide components that interact with the functions at individual layers of the OSI stack, as well as components that interact with functions in multiple layers of the stack. For example, some embodiments of the invention include components that each interact with functions of one of the lower four layers of the stack (i.e., the transport, network, data link and physical layers), as well as components that span more than one layer. The components may log events occurring at each layer, implement rulesets in the form of programmed logic designed to determine whether an event (or group of events) indicates a connectivity problem, and provide controls for recovery and recovery verification.

In some embodiments, the health monitor may implement self-throttling functionality, so that the execution of health monitor components has minimal effect on the device's power, processing performance and storage capacity. Some embodiments may also, or alternatively, provide an application programming interface (API) that enables applications executing on the device to provide information to, and receive date from, the health monitor. For example, an application may employ an API to identify suspected connectivity-related issues to the health monitor, so that components of the health monitor may investigate and take action if necessary.

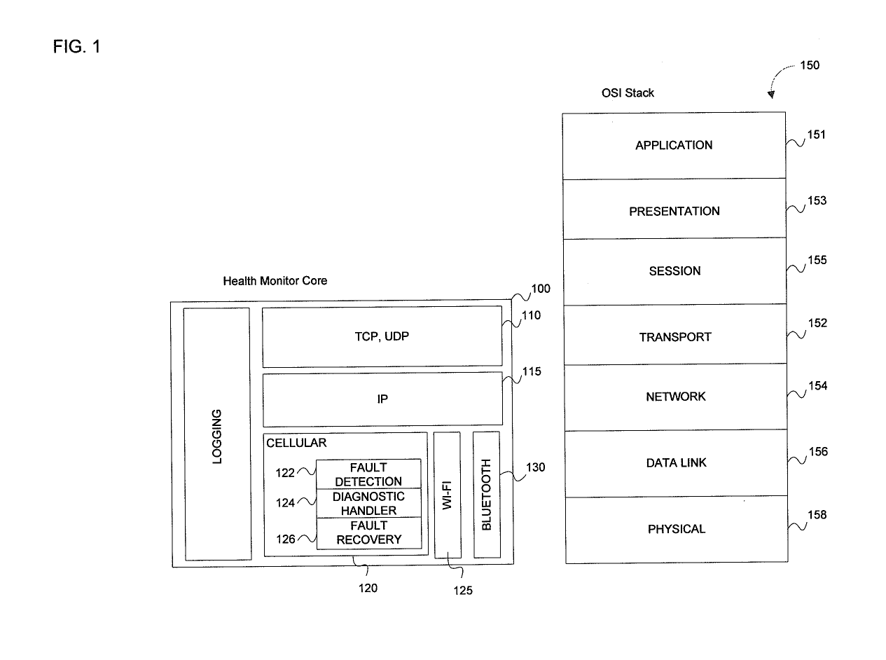

Depicted in FIG. 1 is a conceptual representation of the components of the health monitor core in relation to the OSI seven-layer stack. In FIG. 1, health monitor core 100 includes components which interact with functions at the transport layer 152, network layer 154, data link layer 156 and physical layer 158 within OSI stack 150. Specifically, component 110 interacts with functions at transport layer 152. In the example shown, component 110 interacts with functions employing the TCP and UDP protocols within transport layer 152 in OSI stack 150. Similarly, component 115 interacts with functions employing the IP protocol in network layer 154.

Component 120 interacts with functions on data link layer 156 and physical layer 158. Specifically, in the example shown, component 120 interacts with functions employing a cellular protocol. Component 120 includes fault detection component 122, diagnostic handler component 124, and fault recovery component 126, each of which interacts with functions employing the cellular protocol at data link layer 156 and physical layer 158. Similar to component 120 which interacts with functions employing a cellular protocol, component 125 interacts with functions employing the IEEE 802.11x protocol, and component 130 interacts with functions employing the Bluetooth protocol.

Logging component 135 records events observed within the transport layer 152, network layer 154, data link layer 156 and physical layer 158. In this regard, logging component 135 “spans” these layers of OSI stack 150. Of course, the invention is not limited to employing a single component which spans multiple layers of the OSI stack, as the invention may be implemented in any of numerous ways, including with several components which each log events occurring within a particular layer of the stack.

The components of health monitor core 100 which correspond to layers of OSI stack 150 may interact with functions at layers of the stack in any of numerous ways. For example, the components may monitor events occurring at each layer of the stack, and when an event occurs, implement one or more rule sets defining a manner of handling, diagnosing, and/or repairing a condition at the layer which gives rise to the event. As a result, the components of health monitor core 100 provide a capability to resolve issues in a manner that is specific to one or more individual layers. Of course, as logging component 135 shown in FIG. 1 illustrates, the components of health monitor core 100 may also, or alternatively, provide a capability to monitor communications at multiple layers of the stack, and provide functionality for detecting and resolving issues at multiple layers. Any one or more components of health monitor core 100 may monitor and/or act on issues discovered at layer or layers within the stack, as embodiments of the invention are not limited in this respect.

It should be appreciated that although the example implementation of health monitor core 100 shown in FIG. 1 includes components which each mirror a layer of the OSI stack, embodiments of the invention are not limited to being implemented in this manner, and may be implemented in any of numerous ways. It should also be appreciated that embodiments of the invention are not limited to interacting with functions at each layer which employ the specific communication protocols shown in FIG. 1, as these protocols are given as examples only.

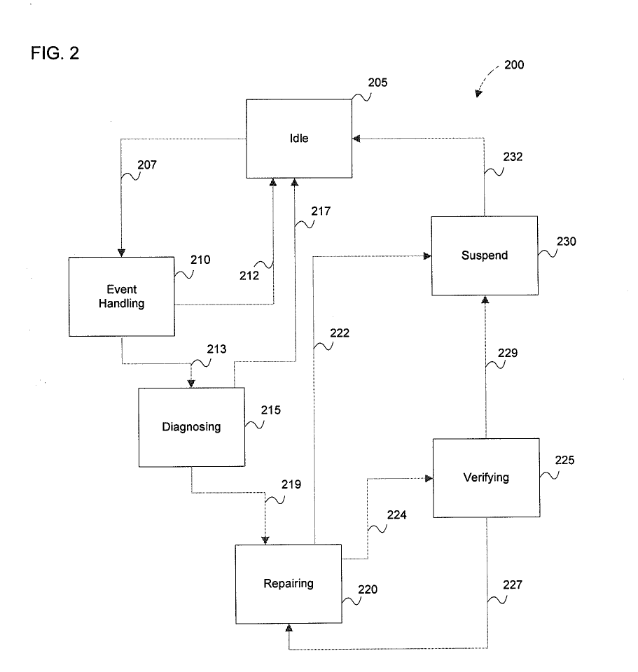

In some embodiments, health monitor core 100 is implemented as a state machine comprising the states and transitions depicted in FIG. 2, including idle state 205, event handling state 210, diagnosing state 215, repairing state 220, verifying state 225 and suspend state 230. In the example shown, idle state 205 is a starting state for health monitor core 100. Upon a specified event being observed, transition 207 is initiated, so that health monitor core 100 transitions to event handling state 210. For example, health monitor core 100 may transition from idle state 205 to event handling state 210 when one or more events that may indicate a connectivity-related issue are detected by a component of health monitor core 100, or an application registers an indication that one or more such events have occurred.

Observed events may be associated with any or all of the layers of the OSI stack, and may relate to communications using any of numerous protocols. Observed events may, for example, be logged, and log entries may drive subsequent analysis of connectivity-related issues. In addition, the actions taken by the health monitor itself may be logged. Logging may be performed, for example, in a manner that minimizes the impact of the health monitor's execution on the handheld device's power supply, processing and storage capacity. For example, some embodiments of the invention allow the extent to which events and/or actions are logged to be configured, either locally on the device and/or remotely. For example, a mobile network operator which determines a sharp increase in a certain type of error may remotely initiate an increase in the granularity at which events or actions are logged, so as to diagnose the problem. Once the problem has been resolved, the mobile operator may resume normal logging, minimizing the health monitor's power, processing and storage needs. Some embodiments of the invention may employ the Event Tracing Window (ETW) mechanism offered by Microsoft Corporation of Redmond, Wash., to perform logging, and may transfer logged information in a manner which maintains the privacy of each handheld device and its user. The invention is not limited to such an implementation, as logging and data transfer may be performed in any suitable manner, using any suitable tool(s) and/or technique(s).

Health monitor core 100 may transition from event handling state 210 to either diagnosing state 215, if it is determined that the observed event(s) may constitute an error that should be diagnosed, or back to idle state 205 if it is determined that the observed event(s) do not indicate an error having occurred. For example, in some embodiments, health monitor 100 may determine the state of the connection and signal strength to determine whether the observed event(s) indicate a possible error having occurred, as opposed to a mere temporary delay or packet retransmission, and transition 213 to diagnosing state 215 only if the signal strength is greater than zero and a connection exists. The presence or absence of a connection when the signal strength is zero, and the absence of a connection when signal strength is greater than zero, may, for example, be deemed normal occurrences that do not indicate an error. As such, in the example shown, these events are logged and health monitor 100 may transition 212 to idle state 205. Of course, a determination whether one or more observed events indicate an error having occurred may be made in any of numerous ways, and embodiments of the invention are not limited to doing so using signal strength or connection state, or using any particular technique.

Health monitor core 100 may transition from diagnosing state 215 to either repairing state 220, if it is determined that an error has occurred, or idle state 205, if it is determined that no error has occurred. For example, health monitor 100 may ping a predetermined address (e.g., an address supplied by an application that notifies health monitor 100 of an event that may indicate an error, or another address) to determine whether a connection to the address can be established. If the ping is acknowledged, health monitor 100 may determine that no error has occurred, and transition 217 to idle state 205. Conversely, if the ping is not acknowledged, health monitor 100 may transition 219 to repairing state 220 to repair the error. Of course, a determination whether an error has occurred may be made in any of numerous ways, and embodiments of the invention are not limited to doing so by pinging an address, or using any particular technique.

Health monitor core 100 may transition from repairing state 220 to verifying state 225, if an attempted repair was completed, or to suspend state 230, if an attempted repair was not completed. For example, health monitor 100 may, for example, attempt to repair an error by resetting a Packet Data Protocol (PDP) context and/or detaching and re-attaching a connection. If either or both of these attempted repairs could not be completed, then health monitor 100 may transition 222 to suspend state 230, and if the attempted repair(s) were completed, then health monitor 100 may transition 224 to verifying state 225. Of course, embodiments of the invention are not limited to attempting to repair an error by resetting a Packet Data Protocol (PDP) context and/or detaching and re-attaching a connection, as this may be performed in any of numerous ways.

Health monitor 100 may transition from verifying state 225 back to repairing state 220, if a completed repair could not be verified as successful, or to suspend state 230, if a completed repair was verified as successful. For example, health monitor 100 may attempt to ping a predetermined address (e.g., the back-end server or service to which connection was originally attempted, or another server or service), and if the ping is acknowledged, then health monitor 100 may transition 229 to suspend state 230, and if not, health monitor 100 may transition 227 back to repairing state to attempt the repair again. Of course, repair may be verified in any of numerous ways, and pinging an address is but one example. For example, health monitor 100 could alternatively query an application on the device to determine whether its connectivity has resumed.

Health monitor 100 transitions 232 from suspend state 230 to idle state 205. In some embodiments, transition 232 occurs after a suspension timer elapses, so that health monitor 100 resumes idle state 205.

It should be appreciated that the states and transitions described above with reference to FIG. 2 are merely examples, and that health monitor 100 may assume any of numerous states, including those described and others not described, and transition between states in ways not described with reference to FIG. 2.

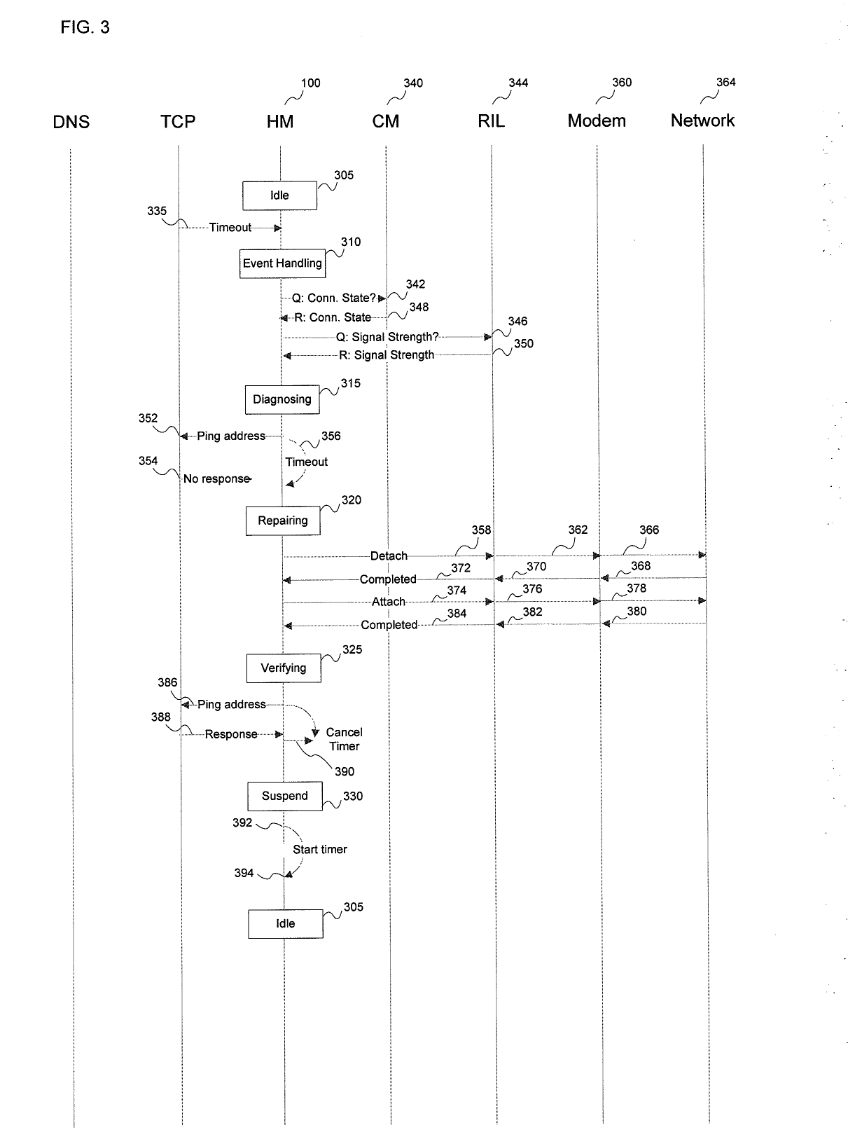

FIG. 3 is a sequence diagram 300 which depicts an example progression between states upon an event occurring. Specifically, in the example of FIG. 3, a Transmission Protocol Protocol (TCP) timeout occurs, causing health monitor 100 to transition between the states described above with reference to FIG. 2.

It should be appreciated that the occurrence of a TCP timeout on the transport layer 152 (FIG. 1) of OSI stack 150 may or may not indicate a failure on a lower level of the stack (i.e., on network layer 154, data link layer 156 and/or physical layer 158). In this respect, the TCP protocol provides for a five second timeout when a communication sent is not acknowledged, after which the communication is re-transmitted. The occurrence of a TCP timeout may indicate a normal delay due to any of numerous factors, including the manner in which network components are organized, latency on the network, a lack of response by a server to which a connection is attempted, etc. However, the occurrence of a TCP timeout may also be due to an error on one or more lower levels of the stack, where protocols are employed which have longer timeout periods. As a result, a TCP timeout (or other timeout occurring at a higher level of the stack) may be an “early indicator” of an error on a lower level of the stack, and acting on the TCP timeout before the longer timeouts used at these lower layers elapse may enable quicker recovery from the error. In some embodiments, health monitor 100 includes components which seek information on issues occurring at individual layers, so that errors can be diagnosed and acted upon as quickly as possible. Because these components may act on each layer separately, health monitor 100 may precisely target errors on the level at which they occur, rather than having to adopt a “blanket” solution.

At the start of the sequence shown in FIG. 3, health monitor (HM) 100 is in idle state 305 when a TCP timeout occurs at 335, causing health monitor 100 to transition to event handling state 310. In the example shown, health monitor determines whether the TCP timeout should be diagnosed as a possible error by querying connection monitor (CM) 340 at 342 to determine whether a connection exists and querying radio interface layer to determine the strength of signal at 346. At 348 and 350, respectively, CM 340 and RIL 344 respond to these queries with indications that a connection exists (in 348) and that the signal strength is greater than zero (in 350), indicating that a possible error exists which should be diagnosed and causing health monitor 100 to transition to diagnosing state 315.

Health monitor 100 then attempts to ping a predetermined address at 352, and receives no response 354 within timeout period 356, indicating an error exists and causing health monitor 100 to transition to repairing state 320.

Applicants have recognized that detaching and reattaching a connection to a gateway on the network may “flush out” errors (e.g., state mismatches) in lower levels of the OSI stack. As a result, in the example of FIG. 3, health monitor 100 instructs RIL 344 to detach the connection at 358, causing RIL 344 to forward the instruction to modem 360 at 362, which then passes the instruction to network gateway 364 at 366. Network gateway 364 then passes an indication that the connection has been detached to modem 360 at 368, which passes the indication to RIL 344 at 370, which in turn passes the indication to health monitor 100 at 372. Health monitor 100 then instructs RIL 344 to re-attach a connection at 374, causing RIL 344 to forward the instruction to modem 360 at 376, which then passes the instruction to network gateway 364 at 378. Network gateway 364 then passes an indication that the connection has been re-attached to modem 360 at 380, which passes the indication to RIL 344 at 382, which in turn passes the indication to health monitor 100 at 384, causing the health monitor to transition to verifying state 325.

Using this technique, if an error has occurred on a lower level of the stack, a connection can be re-set and connectivity restored as quickly as possible. As a result, if a state mismatch occurs, or if an error occurs due to a weak signal because the user is driving through a tunnel or reaches a location where a switch of cell towers is needed, at a time when others also transferring data attempt to also switch to the same tower, connectivity may be restored quickly.

Health monitor 100 then pings an address (e.g., the same address pinged at 352) at 386. A response is received at 388 prior to cancel timer 390 elapsing, causing health monitor 100 to transition to suspended state 330. Health monitor 100 then starts a suspension timer at 392, which elapses at 394, causing health monitor to transition to idle state 305. The sequence diagram of FIG. 3 then completes.

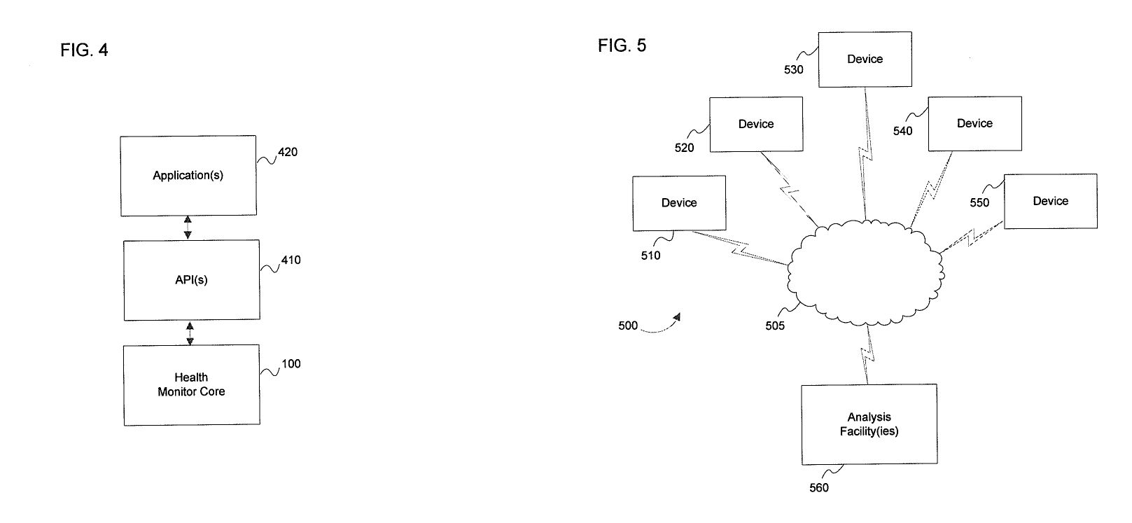

FIG. 4 depicts an example application programming interface (API) 410 provided by health monitor 100 for one or more applications 420 on a device. Using API 410, application(s) 420 may provide information to health monitor 100, such as an indication that an event occurred which may indicate a connectivity-related issue, and receive information from health monitor 100, such as an indication that an error was averted or resolved. It should be appreciated that the arrangement depicted in FIG. 4, in which a single API is provided for one or more applications, is merely an example, and more than one API may be provided, each of which may provide an interface for one or more applications. Embodiments of the invention are not limited to any particular implementation.

FIG. 5 depicts an example system which allows information on events and actions taken in response thereto to be collected by one or more analysis facilities 560 from multiple handheld devices 510, 520, 530, 540 and 550. For example, each of handheld devices 510, 520, 530, 540 and 550 may transmit information to the one or more analysis facilities 560, such as using the Software Quality Management (SQM) facility offered by Microsoft Corporation of Redmond, Wash. Of course, embodiments of the invention are not limited to using SQM to transmit information, as any suitable technique(s) or tool(s) may be employed.

The one or more analysis facilities 560 may aggregate and analyze information received from various handheld devices, such as to determine error patterns and/or trends among data received from the devices. For example, information from devices 510-550 may be segmented based on mobile operator, device, time of day, and/or any other criteria, to determine (as examples) that certain events occurs on a particular device or device type during a specific time of day. This type of data may, for example, be useable by a mobile operator to indicate the infrastructure improvements that may benefit the user community. For example, a significant increase in dropped connections at a particular time of day at a certain location (e.g., at 9:00 am outside a subway station) may indicate that the user community may benefit from an additional cell tower nearby. Any of numerous conclusions may be drawn from information received from handheld devices, and the invention is not limited in this respect.

The system of FIG. 5 can also be used to distribute information to any or all of handheld devices 510-550. For example, the one or more analysis facilities may employ network 505 to send a new version of the health monitor to any or all of the devices for implementation of new features. In this respect, it should be appreciated that embodiments of the invention may provide a framework for evolution and update, whereby rule sets defining error checks, recovery steps, etc. may be “pushed” to individual devices based on information previously captured. For example, as users of devices 510-550 encounter events analyzed by respective health monitors and information regarding those events and actions responsive thereto are analyzed, newer versions of the health monitor may be pushed to devices to continually improve on its effectiveness in managing connectivity-related issues.

In some embodiments, rule sets define not only how events are qualified, what actions are taken and how recovery is verified, but also the overall behavior of the health monitor, so as to minimize the impact on the device's power supply and/or performance. For example, if the strength of a cellular signal is low, the health monitor may “self-throttle,” so that components do not continually kick off and attempt to determine whether an error condition exists, thereby consuming power and process recycles. Similarly, the health monitor may self-throttle if it determines that an error exists over which the device has little control. For example, if the user drives through a tunnel or enters a subway, so that the device receives little or no signal, the health monitor may self-throttle so that its components do not consume power and/or the process recycles until signal strength is restored (e.g., when the user exits the subway), so as to minimize over-all system impact.

It should be appreciated that although some of the description above references mobile handheld devices which employ RF connections to connect to the Internet, embodiments of the invention are not so limited. For example, embodiments of the invention need not be employed to manage connectivity to the Internet, and may be employed to manage connectivity to any one or more types of networks, including local and/or wide area networks, other type(s) of network, or any combination thereof. In addition, embodiments of the invention need not be used to connect to a network at all, and may be used, as an example, to manage connectivity between a handheld device and one or more other devices, such as a remote data store, wireless access point, other type(s) of device(s), or any combination thereof. When employed to manage network connectivity, any suitable network infrastructure and/or communication protocol(s) may be employed. For example, any suitable one or more cellular network types (e.g., GSM, CDMA, LTE, other type(s), or any combination thereof) may be used. It should also be appreciated that embodiments of the invention are not limited to devices which use RF to establish connectivity, and may be used with any suitable type(s) of electromagnetic radiation or other medium to accomplish communication. Embodiments of the invention are not limited to any particular implementation.

It should further be appreciated that the term “handheld device” as used herein encompasses within its scope any suitable device(s), including a laptop computer, desktop computer, control/monitoring system, application-specific integrated circuit (ASIC), music and/or video player, gaming console, other type(s) of device(s), or any combination thereof. Any suitable one or more devices may be employed, as embodiments of the invention are not limited to any particular implementation.

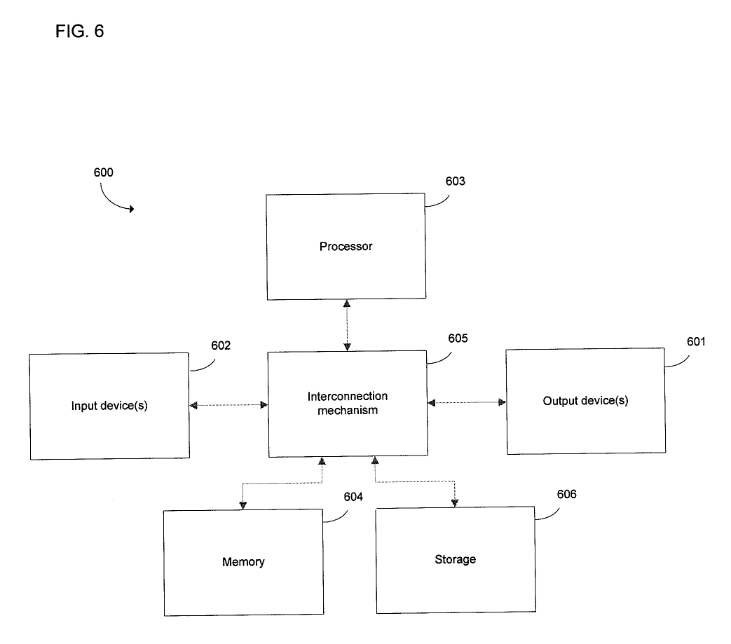

Various aspects of the systems and methods for practicing features of the invention may be implemented on one or more computer systems, such as the exemplary computer system 600 shown in FIG. 6. Computer system 600 includes input device(s) 602, output device(s) 601, processor 603, memory system 604 and storage 606, all of which are coupled, directly or indirectly, via interconnection mechanism 605, which may comprise one or more buses, switches, networks and/or any other suitable interconnection. The input device(s) 602 receive(s) input from a user or machine (e.g., a human operator), and the output device(s) 601 display(s) or transmit(s) information to a user or machine (e.g., a liquid crystal display). The input and output device(s) can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

The processor 603 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

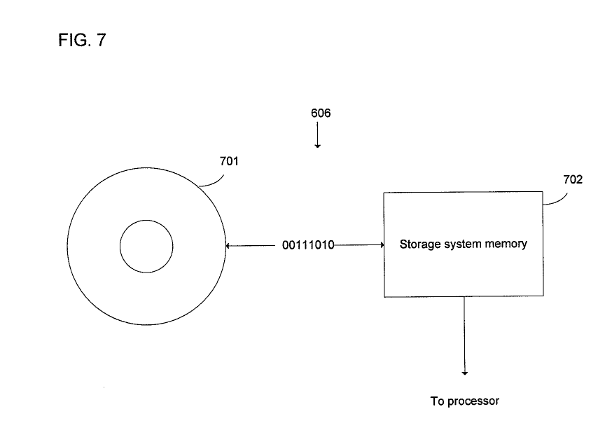

Processor 603 may also execute one or more computer programs to implement various functions. These computer programs may be written in any type of computer program language, including a procedural programming language, object-oriented programming language, macro language, or combination thereof. These computer programs may be stored in storage system 606. Storage system 606 may hold information on a volatile or non-volatile medium, and may be fixed or removable. Storage system 606 is shown in greater detail in FIG. 7.

Storage system 606 may include a tangible computer-readable and -writable non-volatile recording medium 701, on which signals are stored that define a computer program or information to be used by the program. The recording medium may, for example, be disk memory, flash memory, and/or any other article(s) of manufacture usable to record and store information. Typically, in operation, the processor 603 causes data to be read from the nonvolatile recording medium 701 into a volatile memory 702 (e.g., a random access memory, or RAM) that allows for faster access to the information by the processor 603 than does the medium 701. The memory 702 may be located in the storage system 606 or in memory system 604, shown in FIG. 6. The processor 603 generally manipulates the data within the integrated circuit memory 604, 702 and then copies the data to the medium 701 after processing is completed. A variety of mechanisms are known for managing data movement between the medium 701 and the integrated circuit memory element 604, 702, and the invention is not limited to any mechanism, whether now known or later developed. The invention is also not limited to a particular memory system 604 or storage system 606.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An apparatus for use in a system in which a framework comprising a plurality of layers is used to perform communications, each of the plurality of layers of the framework comprising one or more functions employing a communications protocol, the apparatus comprising at least one processor programmed to:
(A) execute a plurality of components, each component corresponding to one of the plurality of layers, each component being operable to interact with the one or more functions at the layer corresponding to the component;
(B) employ one of the components to observe an event with respect to the layer corresponding to the one component;
(C) determine that the event indicates an error relating to a communication; and
(D) initiate a repair of the error.

2. The apparatus of claim 1, wherein the system comprises a cellular network.

3. The apparatus of claim 1, wherein the plurality of layers comprise application, presentation, session, transport, network, data link, and physical layers.

4. The apparatus of claim 1, wherein the apparatus executes an operating system, and at least a portion of the plurality of components are components of the operating system.

5. The apparatus of claim 1, wherein (A) further comprises executing at least one component that corresponds to more than one of the plurality of layers, the at least one component being operable to interact with one or more functions at each of the more than one layers.

6. The apparatus of claim 1, wherein the plurality of layers are organized into a stack which includes a first layer and a second layer, and wherein the at least one processor is further programmed to, in (B), employ a first component to observe an event with respect to the first layer, and in (D), initiate a repair of the error by taking an action with respect to the second layer.

7. The apparatus of claim 6, wherein the first layer is higher on the stack than the second layer.

8. The apparatus of claim 1, wherein the apparatus is operable to execute an application, and wherein the at least one processor is further programmed to provide an interface enabling the application to indicate an occurrence of an event indicating a suspected error.

9. The apparatus of claim 1, wherein the at least one processor is further programmed to record in a log one or more of an indication of the observed event, of an error determined to be indicated by the observed event, and of an action taken to initiate the repair of the error.

10. The apparatus of claim 9, wherein the at least one processor is further programmed to transmit contents of the log to an analysis facility.

11. The apparatus of claim 10, wherein the at least one processor is further programmed to receive from the analysis facility an update to one of the plurality of components and to install the update to update the one component.

12. At least one tangible computer-readable storage medium having instructions recorded thereon which, when executed, perform a method for use in a system in which a plurality of devices each employ a framework comprising a plurality of layers to perform communications, each of the plurality of layers of the framework comprising one or more functions employing a communications protocol, each of the plurality of devices executing a plurality of components each corresponding to one of the plurality of layers, each component being operable to interact with the one or more functions at a layer corresponding to the component, the method comprising acts of:
(A) receiving, from each of the plurality of devices, an indication of:
an event observed by a component executing on the device;
a determination that the event indicates an error relating to a communication performed by the device; or
at least one action taken by the device to initiate a repair of the error; and
(B) storing the indications received from the plurality of devices; and
(C) analyzing the indications to determine a characteristic shared by at least a portion of the indications.

13. The at least one tangible computer-readable storage medium of claim 12, wherein (A) further comprises receiving an indication of a mobile operator associated with each of the plurality of devices, and receiving from each of the plurality of devices a time of day at which the event was observed.

14. The at least one tangible computer-readable storage medium of claim 12, wherein the method further comprises an act of:
(D) transmitting to each of the plurality of devices an update to a component executing on the device.

15. The at least one tangible computer-readable storage medium of claim 14, wherein the update transmitted in (D) relates to the characteristic determined in (C).

16. The at least one tangible computer-readable storage medium of claim 14, further comprising an act of:
(E) receiving the update to the component; and
(F) installing the update.

17. A method for use in a system in which a framework comprising a plurality of layers is used to perform communications, each of the plurality of layers of the framework comprising one or more functions employing a communications protocol, the method comprising acts of:
(A) observing an event occurring at one of the plurality of layers of the framework;
(B) determining that the event indicates an error relating to a communication employing the framework;
(C) taking an action at one of the plurality of layers of the framework to initiate a repair of the error.

18. The method of claim 17, wherein (C) comprises taking the action at the same layer of the framework at which the event is observed in (A).

19. The method of claim 17, wherein the plurality of layers of the framework comprise a first layer and a second layer, the act (A) comprises observing the event at the first layer, and the act (B) comprises taking an action at the second layer.

20. The method of claim 19, wherein the plurality of layers of the framework are organized into a stack, and the first layer is higher on the stack than the second layer.
